(19) United States
(12) Patent Application Publication
(10) Pub. No.: US 2019/0339082 A1
(43) Pub. Date: Nov. 7, 2019

(54) METHOD AND SYSTEM FOR HYBRID COLLECTIVE PERCEPTION AND MAP CROWDSOURCING

(71) Applicant: BlackBerry Limited, Waterloo (CA)

(72) Inventors: Ian Christopher Drummond DOIG, Roquefort les Pins (FR); James Randolph Winter LEPP, Ottawa (CA); Stephen MCCANN, Southampton (GB); Michael Peter MONTEMURRO, Toronto (CA); Stephen John BARRETT, Haywards Heath (GB)

(21) Appl. No.: 15/969,259

(22) Filed: May 2, 2018

(51) Int. Cl. G01C 21/32; G06F 17/30

(52) U.S. Cl. CPC G01C 21/32; G06T 11/60; G06F 17/30575; G06F 17/30241

(57) ABSTRACT

A method at a network element for collective perception in an intelligent transportation system, the method including receiving, from each of a plurality of intelligent transportation system stations, a local dynamic map; creating, based on the local dynamic map from each of the plurality of intelligent transportation system stations, a local collective perception map; and distributing the local collective perception map to at least one of the plurality of intelligent transportation system stations.

### FIELD OF THE DISCLOSURE

The present disclosure relates to intelligent transportation systems (ITS) and, in particular, relates to mapping and object tracking for ITS stations.

### BACKGROUND

Intelligent transport systems are systems in which a plurality of devices communicate to allow for the transportation system to make better informed decisions with regard to transportation and traffic management, as well as allowing for safer and more coordinated decision-making. ITS system components may be provided within vehicles, as part of the fixed infrastructure such as on road verges, on bridges or at intersections, and for other users of the transportation systems including pedestrians or bicyclists.

ITS system deployment is receiving significant focus in many markets around the world, with radiofrequency bands being allocated for the communications. In addition to vehicle to vehicle communications for safety critical and non-critical applications, further enhancements are being developed for vehicle to infrastructure and vehicle to portable scenarios.

An ITS station is any entity that may provide ITS communications, including vehicles, infrastructure components, mobile devices, among other options. Such ITS communications currently provide information regarding the vehicle, its direction of travel, the size of the vehicle, among other similar information. However, no collective perception amongst ITS stations currently exists for various temporary hazards such as collisions, road debris, lane changes, or other road obstacles.

### BRIEF DESCRIPTION OF THE DRAWINGS

The present disclosure will be better understood with reference to the drawings, in which:

FIG. 1 is block diagram of an intelligent transportation system;

FIG. 2 is a block diagram showing a local dynamic map within an ITS station;

FIG. 3 is a block diagram showing cooperative awareness message formats for both legacy and extended cooperative awareness message;

FIG. 4 is a block diagram showing a format for an environmental perception message;

FIG. 5 is a block diagram showing communication of wide area collective perception map data to remote stations;

FIG. 6 is a process diagram showing a process for updating local dynamic maps and local collective perception maps;

FIG. 7 is a dataflow diagram showing updating and use of wide area collective perception map data;

FIG. 8 is a process diagram showing a process for identifying and providing information for vehicles that are not part of an intelligent transportation system;

FIG. 9 is a block diagram showing detection and communication of data regarding a vehicle that is not part of an intelligent transportation system;

FIG. 10 is a process diagram showing a process for avoiding or reducing duplicate reporting about perceived objects; and

FIG. 11 is a block diagram of an example computing device capable of being used with the embodiments of the present disclosure.

### DETAILED DESCRIPTION OF THE DRAWINGS

The present disclosure provides a method at a network element for collective perception in an intelligent transportation system, the method comprising: receiving, from each of a plurality of intelligent transportation system stations, a local dynamic map; creating, based on the local dynamic map from each of the plurality of intelligent transportation system stations, a local collective perception map; and distributing the local collective perception map to at least one of the plurality of intelligent transportation system stations.

The present disclosure further provides a network element for collective perception in an intelligent transportation system, the network element comprising: a processor; and a communications subsystem, wherein the network element is configured to: receive, from each of a plurality of intelligent transportation system stations, a local dynamic map; create, based on the local dynamic map from each of the plurality of intelligent transportation system stations, a local collective perception map; and distribute the local collective perception map to at least one of the plurality of intelligent transportation system stations.

The present disclosure further provides a computer readable medium for storing instruction code, which, when executed by a processor of a network element configured for collective perception in an intelligent transportation system cause the network element to: receive, from each of a plurality of intelligent transportation system stations, a local dynamic map; create, based on the local dynamic map from each of the plurality of intelligent transportation system stations, a local collective perception map; and distribute the local collective perception map to at least one of the plurality of intelligent transportation system stations.

In the embodiments described below, the following terminology may have the following meaning, as provided in Table 1.

TABLE 1
Terminology

| Term | Brief Description |
|---|---|
| 3GPP C-V2X | Third Generation Partnership Project |
| | (3GPP) Cellular Vehicle-to-Everything |
| | (V2X) |
| B-frame | Bidirectional predicted picture frame. This |
| | includes a delta between previous and |
| | subsequent frames. |
| CAM | Cooperative Awareness Message (e.g. see |
| | ETSI EN 302 637-2), relevant to periodic |
| | beaconing of vehicle positions. The main |
| | use of these messages is in car crash |
| | avoidance applications or assistance |
| | applications. In some implementations they |
| | may only be sent direct to other vehicles via |
| | a local area broadcast mechanism, whilst in |
| | other implementations they may be |
| | transmitted from one vehicle to other |
| | vehicles via infrastructure. |
| CPM | A Collective Perception Map, which is a |
| | local dynamic map containing information |
| | on perceived objects |
| DENM | Decentralized Environmental Notification |
| | Message, related to event detection and |
| | dissemination. For example, see ETSI EN |
| | 302 637-3 |
| DSRC (Dedicated Short Range | A two-way short to medium range wireless |
| Communications) | communications capability that permits very |
| | high data transmission critical in |
| | communications-based active safety |
| | applications. The FCC allocated 75 MHz of |
| | spectrum in the 5.9 GHz band for use by |
| | Intelligent Transportations Systems (ITS) |
| | vehicle safety and mobility applications. |
| eNodeB | Long Term Evolution (LTE) Radio Network |
| | Base Station |
| Fusion | The process of combining two or more |
| | distinct entities into a new single entity. |
| l-frame | Intra-coded picture frame. This includes a |
| | complete representation or image. Also |
| | known as a keyframe. |
| ITS Station | A V2X capable entity/device connected to |
| | an V2X system e.g. a V2X vehicle or an |
| | RSU. |
| ITS | Intelligent Transport System consisting of |
| | V2X vehicles, RSUs (e.g. traffic lights) and |
| | a Vehicular ad-hoc network (VANET) |
| ITS G5 | In Europe V2V is standardized as ETSI ITS- |
| | G5, a standard based on IEEE 802.11p for |
| | use of the 5 875-5 905 MHz frequency band |
| | for transport safety ITS applications. |
| LDM | Local Dynamic Map, a map of local area |
| | typically maintained by a vehicle with |
| | dynamic information supplied by RSUs or |
| | V2X vehicles. |
| LCPM | Local Collective Perception Map, A LDM |
| | containing derived perceived information |
| | from over a wide area. |
| LTE-PC5 | 3GPP device to device LTE radio interface |
| | (also known as sidelink at the physical |
| | layer). |
| RMAP | Regional Dynamic Map, typically |
| | maintained by an RSU. |
| Non-V2X vehicle | Vehicle with no ITS station capability or has |
| | its capability disabled. |
| P-frame | Predicted picture frame. This includes a |
| | delta or changes from the previous frame. |
| ProSe (Proximity Services) | A Device-to-Device LTE technology that |
| | allows devices to detect each other and to |
| | communicate directly. |
| RSU (Road Side Unit) | A fixed ITS Station |
| V2X vehicle | A vehicular ITS Station |
| Object | Any non-ITS factor impacting road users |
| | (pot hole, road obstruction/debris). |
| Perceived object | Objects that have been detected and |
| | recognized by the ITS Station as road users |
| | or objects not equipped with an ITS Station. |
| Proxy ITS station | ITS station sending information on behalf of |
| | a non-ITS Vehicle. |
| Sensor fusion | Sensor fusion is the combining of sensory |
| | data or data derived from different sources |
| | such that the resulting information has less |
| | uncertainty and or requires less bandwidth |
| | to be communicated. |
| Smart phone | A data enabled telephone with a user |
| | interface and video display capabilities. |
| SPaT | Signal Phase and Timing. Data about traffic |
| | signals current and future state. |
| WACPM | Wide Area Cooperative Perception Map. |

Intelligent Transportation System software and communication systems are designed to enhance road safety and road traffic efficiency. Such systems include vehicle to/from vehicle (V2V) communications, vehicle to/from infrastructure (V2I) communications, vehicle to/from network (V2N) communications, and vehicle to/from the pedestrian or portable (V2P) communications. The communications from a vehicle to/from any of the above may be generally referred to as V2X. Further, other elements may communicate with each other. Thus, systems may include portable to/from infrastructure (P2I) communications, infrastructure to infrastructure (I2I) communications, portable to portable (P2P) communications, among others. As used herein, V2X thus includes any communication between an ITS station and another ITS station, where the station be associated with a vehicle, RSU, network element, pedestrian, cyclist, animal, among other options.

Such communications allow the components of the transportation system to communicate with each other. For example, vehicles on a highway may communicate with each other, allowing a first vehicle to send a message to one or more other vehicles to indicate that it is braking, thereby allowing vehicles to follow each other more closely.

Communications may further allow for potential collision detection and allow a vehicle with such a device to take action to avoid a collision, such as braking or swerving. For example, an active safety system on a vehicle may take input from sensors such as cameras, radar, LIDAR, and V2X, and may act on them by steering or braking, overriding or augmenting the actions of the human driver or facilitating autonomous driving where a human is not involved at all. Another type of advanced driver assistance system (ADAS) is a passive safety system that provides warning signals to a human driver to take actions. Both active and passive safety ADAS systems may take input from V2X and ITS systems.

In other cases, fixed infrastructure may give an alert to approaching vehicles that they are about to enter a dangerous intersection or alert vehicles to other vehicles or pedestrians approaching the intersection. This alert can include the state of signals at the intersection (signal phase and timing (SPaT)) as well as position of vehicles or pedestrians or hazards in the intersection. Other examples of ITS communications would be known to those skilled in the art.

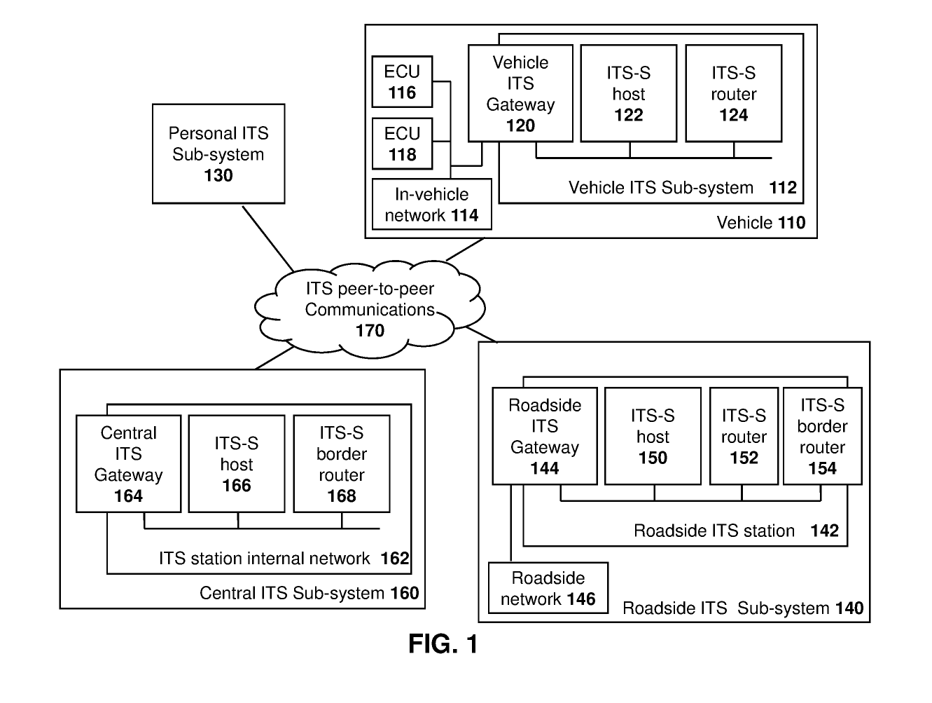

Reference is now made to FIG. 1, which shows one example of an ITS station, as described in the European Telecommunications Standards Institute (ETSI) European Standard (EN) 302665, “Intelligent Transport Systems (ITS); communications architecture”, as for example provided for in version 1.1.1, September 2010.

In the embodiment of FIG. 1, a vehicle 110 includes a vehicle ITS sub-system 112. Vehicle ITS sub-system 112 may, in some cases, communicate with an in-vehicle network 114. The in-vehicle network 114 may receive inputs from various electronic control unit (ECUs) 116 or 118 in the environment of FIG. 1.

Vehicle ITS sub-system 112 may include a vehicle ITS gateway 120 which provides functionality to connect to the in-vehicle network 114.

Vehicle ITS sub-system 112 may further have an ITS-S host 122 which contains ITS applications and functionality needed for such ITS applications.

Further, an ITS-S router 124 provides the functionality to interconnect different ITS protocol stacks, for example at layer 3.

Further, the ITS system of FIG. 1 may include a personal ITS sub-system 130, which may provide application and communication functionalities of ITS communications (ITSC) in handheld or portable devices, such as personal digital assistants (PDAs) mobile phones, user equipment, among other such devices.

A further component of the ITS system shown in the example of FIG. 1 includes a roadside ITS sub-system 140, which may contain roadside ITS stations which may be deployed on bridges, traffic lights, among other options.

The roadside sub-system 140 includes a roadside ITS station 142 which includes a roadside ITS gateway 144. Such a gateway may connect the roadside ITS station 142 with proprietary roadside networks 146.

A roadside ITS station may further include an ITS-S host 150 which contains ITS-S applications and the functionalities needed for such applications.

The roadside ITS station 142 may further include an ITS-S router 152, which provides the interconnection of different ITS protocol stacks, for example at layer 3.

The ITS station 142 may further include an ITS-S border router 154, which may provide for the interconnection of two protocol stacks, but in this case with an external network.

A further component of the ITS system in the example of FIG. 1 includes a central ITS sub-system 160 which includes a central ITS station internal network 162.

The Central ITS station internal network 162 includes a central ITS gateway 164, a central ITS-S host 166 and a ITS-S border router 168. The Gateway 164, central ITS-S host 166 and ITS border router 168 have similar functionality to the gateway 144, ITS host 150 and ITS-S border router 154 of the roadside ITS station 142.

Communications between the various components may occur through a ITS peer-to-peer communications network or via network infrastructure 170.

From FIG. 1 above, V2X communications may be used for road safety, for improving efficiency of road transportation, including movement of vehicles, reduced fuel consumption, among other factors, or for other information exchange.

V2X messages that are defined by the European Telecommunications Standards Institute (ETSI) fall into two categories, namely Cooperative Awareness Message (CAM) and Decentralized Environmental Notification Message (DENM). A CAM message is a periodic, time triggered message which may provide status information to neighboring ITS stations. The broadcast is typically transported over a single hop and the status information may include a station type, position, speed, heading, among other options. Optional fields in a CAM message may include information to indicate whether the ITS station is associated with roadworks, rescue vehicles, or a vehicle transporting dangerous goods, among other such information.

Typically, a CAM message is transmitted between 1 and 10 times per second.

A DENM message is an event triggered message that is sent only when a trigger condition is met. For example, such trigger may be a road hazard or an abnormal traffic condition. A DENM message is broadcast to an assigned relevance area via geo-networking. It may be transported over several wireless hops and event information may include details about the causing event, detection time, event position, event speed, heading, among other factors. DENM messages may be sent, for example, up to 20 times per second over a duration of several seconds.

Similar concepts apply to the Dedicated Short Range Communications (DSRC)/Wireless Access In Vehicular Environments (WAVE) system in which a Basic Safety Message (BSM) is specified instead of the CAM/DENM messaging.

Local Dynamic Map

A Local Dynamic Map (LDM) is the fundamental component of today's collision avoidance systems. Vehicles have a number of local sensors to detect objects around the vehicle and provide the (relative or absolute) location of those objects as input to the LDM.

One of these inputs can be location information of objects from a V2X system (for example V2V location information from another vehicle).

Collision avoidance systems are based on detecting potential collision courses with objects and either warning the user or applying active mitigation such as brakes. Collision avoidance systems use a relative location to avoid collisions, but may in the future use accurate absolute locations and maps to enable more automated driving. For example, V2I MAP/SPaT data about an intersection may in the future be received from an RSU.

An LDM is typically generated by a vehicle's ITS system such as that described in FIG. 1 above. One example of an LDM is provided in the ETSI Technical Report (TR) 102863, “Intelligent Transport Systems (ITS); vehicular communications; basic set of applications; local dynamic map (LDM); rationale for a guidance on standardization”, as provided for example in version 1.1.1, June 2011.

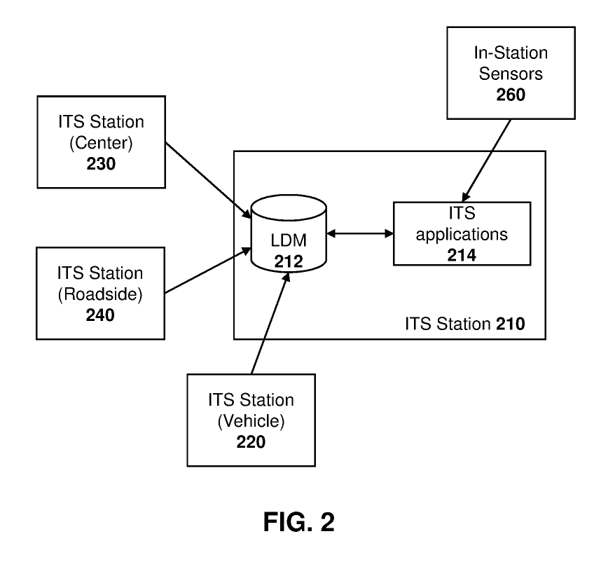

Reference is now made to FIG. 2. Information about the local environment is useful in cooperative ITS systems. ITS applications use information both on moving objects such as other vehicles nearby and on stationary objects such as traffic road signs, among other options. Common information used by different applications may be maintained in an LDM. In some cases, ITS Station 210 is considered the Host Vehicle (HV) and the ITS Station 220 is considered the Remote Vehicle (RV).

Therefore, in the embodiment of FIG. 2, an ITS station 210 includes an LDM 212 along with ITS applications 214.

The LDM 212 is a conceptual data store located within an ITS station 210 and contains information which is relevant to the safe and successful operation of ITS applications 214. Data can be received from a range of different sources such as an ITS station on a vehicle 220, an ITS central station 230, an ITS roadside station 240, along with sensors within ITS station 212, shown by block 260 in the embodiment of FIG. 2.

Read and write access to data held within the LDM 212 is achieved using an interface. The LDM offers mechanisms to grant safe and secured access. Thus, the LDM 212 is able to provide information on the surrounding traffic and RSU infrastructure to applications that need such information.

LDM 212 contains information on real-world and conceptual objects that have an influence on the traffic flow. In some embodiments, the LDM 212 is not required to maintain information on the ITS station it is part of, but may do so if necessary for particular implementations.

LDM 212 may store data describing real-world objects in various categories. For example, four different categories of data are:
Type 1: permanent static data, usually provided by a map data supplier;
Type 2: quasi-static data, obtained during operation, for example changed static speed limits;
Type 3: transient dynamic information such as weather situations and traffic information; and
Type 4: highly dynamic data such as that provided in a cooperative awareness message (CAM).

Typically, the LDM 212 will not contain type 1 data. Not all ITS stations require type 1 data and if such data is needed by an application within ITS station 210, such data may be optimized and stored for the respective specific application. However, as LDM data is potentially relevant for applications that make use of type 1 data, location referencing data relating to the type 2, type 3 and type 4 information to the type 1 map data may be provided. This location referencing may be complex and therefore may require adequate location referencing methods.

As indicated above, type 4 information may include CAM messages. Rather than CAM, in some jurisdictions, basic safety messages (BSM) for V2V safety applications have been defined. In particular, connected V2V safety applications are built around the Society of Automotive Engineers (SAE) J2735, “Dedicated Short Range Communications (DSRC) Message Set Dictionary” BSM, which has two parts.

In the first part, a BSM contains core data elements including vehicle size, position, speed, heading, acceleration, brake system status, among other such information. Such data may be transmitted frequently, for example 10 times per second.

In the second part, BSM data may be added to the first part data depending on events. For example, if an automated braking system is activated then part two data may also be provided. Part two data may contain a variable set of data elements drawn from many optional data elements. It may be transmitted less frequently and may be transmitted independently of the heartbeat messages of the first part.

In one embodiment, BSM messages may be transmitted over Dedicated Short Range Communications (DSRC), which for example may have a range of about 200 meters.

The BSM messages are an alternative standardized set of messages to the ETSI defined CAM and Decentralized Environmental Notification Message (DENM).

ITS Collective Perception

The ITS LDM described above is created with data from an ITS station's own local sensor (cameras, radar, LIDAR etc.), as well as received V2X messages via the ITS, for example CAMs/BSMs from other vehicles reporting their location and heading.

The concept of collective perception is that in addition to information about the vehicle itself, the V2X message also transmits information about other (Dynamic Map) objects the vehicle is aware of from the vehicle's own sensors. For example, a V2V message may come from a vehicle containing information about itself and other non V2X vehicles it detects from its camera system.

Collective perception may be implemented in stages. For example, in a first stage, a vehicle may accumulate information about its own environment, for example about adjacent vehicles and their assorted data. Such data may be relative position, relative speed and derivatives that may be measured or calculated. This may be used for simple systems such as blind spot monitoring to relieve inadvertent lane departures into the path of another vehicle.

In a second stage, environmental information may be shared as a cooperative stream in CAMs/BSMs so that other vehicles that are able to receive the data are aware that the reporting vehicle is in proximity to another vehicle. In this stage, for example, if a traffic light change is in progress at the intersection, then the recipient vehicles might receive estimates of the transit speed across the intersection and whether or not the vehicles will be able to stop.

In a third stage, the single vehicle examples above are extended to a large number of vehicles so that the environmental information is aggregated to yield a collective perception of the roadway dynamic. Each vehicle, through sensor input, such as LIDAR and radar, develops an awareness model of its environment and shares this. This allows receiving vehicles to know about vehicles without the ability to communicate (e.g. non-V2X vehicles) that are in the awareness field of a reporting vehicle. The status of such unequipped vehicles may be reasonably estimated based on their movement within the awareness field of a reporting vehicle. In this case, an Environmental Perception Message (EPM) may be transmitted instead of or in addition to a CAM.

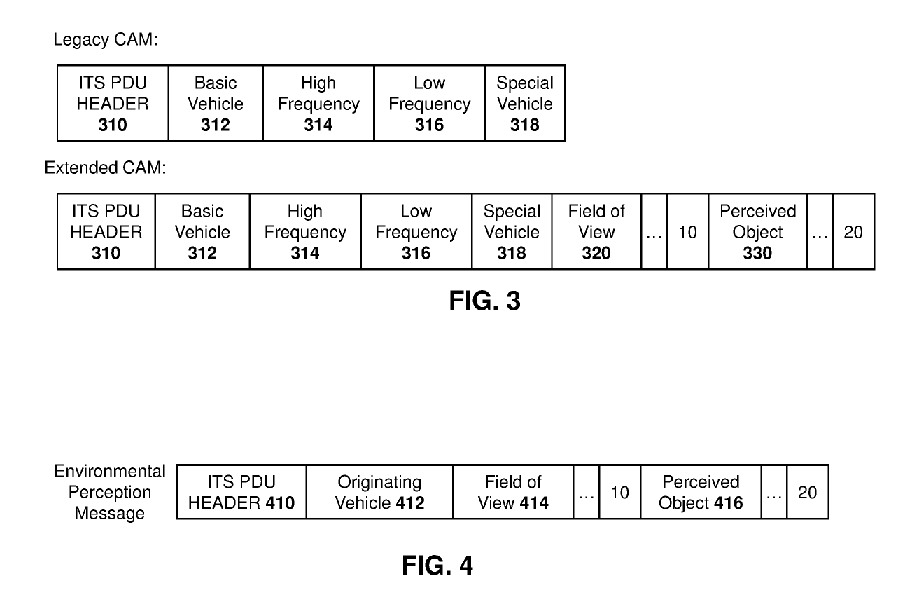

In particular, reference is now made to FIG. 3, which shows the extension of a CAM message to provide for collective perception. In particular, in the embodiment of FIG. 3, a legacy CAM message includes an ITS packet data unit (PDU) header 310. Further, a basic vehicle field 312 and a high frequency field 314 provide data with regard to the vehicle.

Further, a low-frequency field 316 and a special vehicle field 318 are provided.

This legacy CAM message can be adapted into an extended CAM message in which the above fields are extended to include a field of view field 320 which provides for a V2X vehicle's sensory capabilities.

Further, a perceived object field 330 provides for objects perceived by the vehicle.

In other embodiments, rather than extending a CAM, a new environmental perception message may be defined. In such an environmental perception message, an ITS PDU header 410 is provided. Further, the originating vehicle field 412 is an optimized basic vehicle and high-frequency message container.

The field of view field 414 and the perceived object field 416 are similar to, and in some cases may be the same as, field of view field 320 and the perceived object field 330 from the extended CAM message above.

On-Board Diagnostics (OBD)

OBD systems provide a vehicle's self-diagnostic and reporting capability and give access to the status of the various vehicle subsystems. The amount of diagnostic information available via OBD varies with the age of the vehicle.

Tools are available that plug into a vehicle's OBD connector to access OBD functions. These range from simple generic consumer level tools to highly sophisticated Original Equipment Manufacturer (OEM) dealership tools, to vehicle telematic devices.

Mobile device applications allow mobile devices to access data via the vehicle's OBD v2 connector. These applications also allow the vehicle's OBD-II port to access to external systems.

Video Frames

Three types of video frames are typically used in video compression. These video frames are known as I, P, and B frames.

An I-frame (Intra-coded picture frame) provides a complete image, like a JPG or BMP image file.

P and B frames hold only part of the image information (the part that changes between frames), so they need less space in the output file than an I-frame. In particular, a P-frame (Predicted picture frame) holds only the changes in the image from the previous frame. For example, in a scene where a car moves across a stationary background, only the car's movements need to be encoded. The encoder does not need to store the unchanging background pixels in the P-frame, thus saving bandwidth. P-frames are also known as delta-frames.

A B-frame (Bidirectional predicted picture frame) saves even more bandwidth by using differences between the current frame and both the preceding and following frames to specify its content.

Hybrid Collective Perception and Map Crowdsourcing

From the above, while a vehicle to vehicle (V2V) and vehicle to roadside unit (RSU) communications are well-defined for traffic intersections and other static hazards, the concept of collective perception for a broken-down vehicle, roadside debris, or other type of road obstacles is not well-defined.

Collective perception at present is defined for a local area single hop. This may, for example, using transmissions within the 5.9 GHz band, be limited to a radius of approximately 300 m. Advance warnings of dynamic objects for extended ranges (e.g. in the kilometer range) are currently not available. For example, such hazards may be animals on the road, vehicle breakdowns, temporary flooding, partial road blockage, among other such scenarios.

Longer-range warnings of perceived objects may give a driver more time to make alternative route decisions and to enhance preparedness for the object.

Additionally, non-V2X vehicles and other objects can be present in the roadway system and also may need to be monitored. For example, information on the location, speed, and direction of such non-V2X vehicles or other object may be beneficial to V2X vehicles on the road. Further, identification of whether a non-V2X vehicle is parked or causing an obstruction and whether or not a vehicle is capable of any automatic or autonomous actions such as platooning, automatic application of brakes, among other such actions, would be beneficial.

As such, in the embodiments described below, techniques are described for enabling a vehicle ITS station to relay detected information to other vehicles on the road.

Further, in some embodiments below, the issue of sensor fusion is described. In particular, some objects are permanent, some are self-reporting with high degrees of confidence, while some are perceived objects that are reported by a third party based on dynamic sensor data and these objects may be viewed with less confidence. It is unknown how dynamically reported perceived objects are stored, and for how long the data is valid.

Therefore, in accordance with the embodiments described below, an RSU or other server may track over time a collective perception map. Report from vehicles may periodically validate the collective perception map. In this regard, RSUs may not only collect local information, but can forward information further into the network.

Utilizing such merger of LDMs containing many crowd sourced objects allows a highly detailed meta-map. In such a map, some objects may be permanent and some will be dynamic. The embodiments described below provide for the detection and storage of information across many submitted reports. Some embodiments below further provide for the distributed storage of such maps.

Further, maps may include both public and private data. For example, details of objects within a gated compound or private lane may be sensitive and therefore should not be distributed to vehicles without privileges for such information. Thus, in accordance with some embodiments described below, the security and privacy of submitters is maintained.

A further issue is that ITS communications may result in network congestion. Specifically, if each vehicle is reporting obstacles for other vehicles that are many kilometers away, this may cause significant message congestion in wide area communication systems such as a cellular network. In this regard, methods of reducing message size, frequency of transmission, and for enhancing spectrum efficiency are provided in the embodiments below. Further, in some cases duplicate messages may be avoided to increase spectral efficiency.

Wide Area Collective Perception Map (WACPM)

A wide area collective perception map would enable V2X capable vehicles to select various waypoints along the road or at a destination or to have near real-time updates of traffic, objects and road situations showing the selected waypoint or destination perceived objects. In particular, this embodiment gives resolution to individual vehicles or object levels at a long distance.

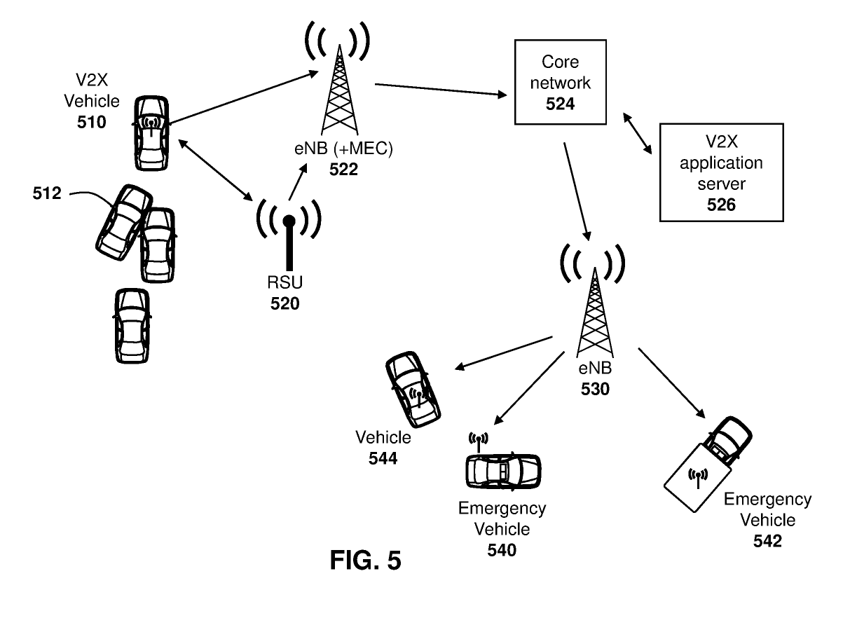

For example, reference is now made to FIG. 5. In the embodiment of FIG. 5, a V2X vehicle 510 perceives an accident 512 which may be blocking several lanes of a roadway. The V2X Vehicle 510 may maintain an LDM and may then communicate such information, for example to an RSU 520 or to a cellular station such as eNB 522. In particular, a communications network (regional or local area) contains a central or edge processing unit, which may for example be co-located at the eNB 522 to perform combining, duplication or fusion of vehicle data and perceived objects.

If the information is collected by the RSU 520, it may then be conveyed, for example, to the eNB 522 in some embodiments. In other embodiments, it may be conveyed directly to a core network 524.

The core network 524 may be any network element or server that is configured for providing map information to the various ITS stations. In some embodiments, the core network 524 may interact with a V2X application server 526. However, a V2X application server 526 is optional. In some embodiments, the functionality of a V2X application server 526 may exist within a core network 524 or within an eNB 522, for example.

Merging or fusing LDMs from various ITS stations, each containing many objects, allows the creation of a highly detailed meta-map entitled a Local Collective Perception Map (LCPM). Some of the objects are permanent and some are dynamic. These LCPMs can also be stored in a distributed manner throughout the network to become a WACPM. For example, in one embodiment the solution may utilize both DSRC/ITS-G5/LTE-PC5 and 3GPP C-V2X as a hybrid network. The LCPM can then be reused in parts or full. For example, details of LCPM objects within a gated compound or on a private country lane may be restricted to a subset of users (with special access) within the network.

Therefore, in accordance with the embodiment of FIG. 5, the RSU 520 or eNB 522 may create a Local Collective Perception Map (LCPM) which may then be sent to a WACPM master networking node such as core network 524.

However, in other embodiments, the WACPM master node may be a V2X application server 526, RSU 520, or use an eNB 522 Mobile Edge Computing (MEC) node. Such a WACPM master unit may then collate information from a plurality of LCPMs.

Alternatively, the WACPM could be distributed between various network nodes, or comprise nodes where information is mirrored between them for business continuity reasons.

Networks of differing technologies and characteristics can be used in combination to provide connectivity between vehicles, objects and the WACPM master unit. Such a network is referred to as a hybrid network (sometimes a hybrid V2X network). The transmission of the LCPM can be over different types of network (e.g. a hybrid network) which collects the input collective perception data. As such, the data can be transmitted on direct links such as DSRC or ITS-G5 or over network links such as cellular data networks.

In some embodiments, a network may have several WAPCMs depending on required coverage area. For example, a single WACPM may cover one geographical district in some cases. Other examples are however possible.

In the embodiment of FIG. 5, the core network may distribute a WACPM to an RSU or an eNB 530 which may then be used to redistribute the information or a portion of the information (for example as a LCPM) to an emergency vehicle 540, a second emergency vehicle 542, or a different V2X vehicle 544, for example. The information may in some cases only be distributed to vehicles for which the information is useful, for example if a vehicle routing causes that vehicle to approach the hazard or other object.

A vehicle such as vehicle 544 which is pre-notified of an object may then, on reaching such object, confirm that the object is still in existence or report to the network the object is no longer valid. For example, a vehicle that is broken down may have been towed away or a roadworks crew may have removed the obstacle in some instances.

An emergency vehicle such as vehicle 540 on route to an accident may have regular updates of objects at the scene of an accident. This may include information such as the number of vehicles involved, the positions or other objects at the scene, among other information that may be generated based on the collective perception of various of vehicles such as vehicle 510 providing information.

In a rural area which has no local RSUs, the network node may broadcast the WACPM or the LCPM directly, for example via Multimedia Broadcast Multicast Services (MBMS), 5G or satellite, to vehicles in that rural geographic area.

In some embodiments, the data stored in the WACPM or the LCPM may be classified. For example, objects in the map may be considered permanent, semi-permanent or instantaneous. A permanent object may be a building or a road in some cases. A semi-permanent object may be a parked vehicle or lane closure. An instantaneous object may be a moving vehicle or pedestrian. Other examples are possible.

The classification of these objects may be programmed, or learned via an algorithm as data is received from sensors and matched with existing data over a long or short time period.

Objects in motion may be classified as instantaneous if sensors are able to detect information such as heading, velocity, acceleration data that may accompany reports about the object. Nodes receiving maps or partial updates of objects may use classification information and other data or properties to construct their LCPM or WACPM.

The embodiment of FIG. 5 provides one example of a system in which a collective map (e.g. an LCPM or a WACPM) may be created for a large area to distribute perceived objects on a roadway. Those of skill in the art will realize that other options for such system are possible.

While the embodiment of FIG. 5 utilizes a cellular network as a wide area network, in other embodiments different wide area networks could be utilized, including networks utilizing access points such as a Wi-Fi or other similar network, or a hybrid network consisting of cellular as well as other access points.

The process of map creation may include LCPM and WACPMs. Each RSU would start with a map that contains stationary components of the roadway in the local geographical area and use incremental updates from vehicles to update its LCPM. It also uses other local data sources such as cameras and environmental sensors. RSUs not only collect local information, but they also communicate with other local RSUs and entities, and may forward information to other nodes within the network.

Once the RSU LCPM is synchronized, the RSU then sends out an updated version of its LCPM to vehicles in the local geographical area.

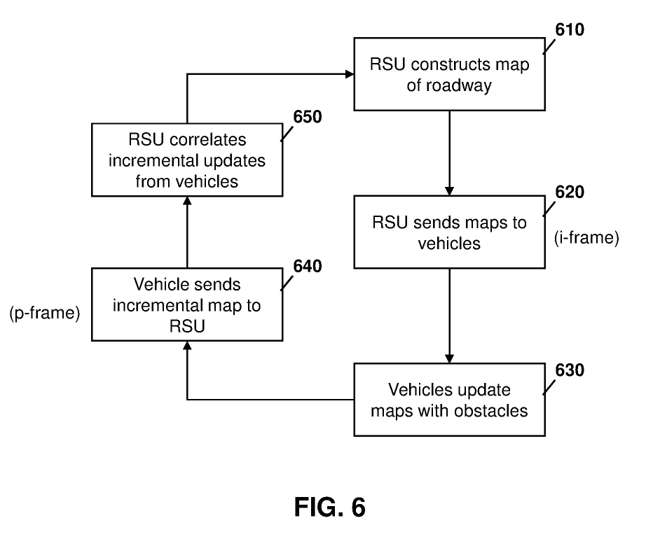

For example, reference is now made to FIG. 6. In accordance with the process of FIG. 6, the RSU may construct an LCPM of the roadway within the local geographical area, as shown at block 610. The process of block 610 may include the synchronization of the LCPM with a centralized WACPM in some cases. However, in other cases, synchronization with the WACPM may occur at different stages.

The process then proceeds to block 620 in which the RSU may send the LCPM to vehicles in the local area. For example, the sending may include the concept of a video keyframe (i-frame) to establish an efficient way to communicate the collective perception of objects detected in a V2X environment. Thus, in the present disclosure, the use of the i-frame is applied to any data, and not just conventional video frame sequences that an i-frame is traditionally used for.

From block 620 the process proceeds to block 630 in which a vehicle may update its LDM with information about obstacles from the LCPM data received from block 620.

The process then proceeds to block 640 in which a vehicle may send incremental LDM updates back to the RSU. In one embodiment, the incremental updates may, for example, be sent as a p-frame. The concept of the delta frame (p-frame) is adapted to establish an efficient way to communicate the collective perception of objects detected in of the V2X environment. Again, the concept is applied to any data and not just conventional video from sequences that traditional p-frames are used for. In an LDM information about some of the moving objects includes heading, speed and acceleration. This information can be used to predict the state or location of object/vehicle between frames or at these delta frame/p-frame times. Therefore, some compression can be achieved by objects on the i-frame LCPM following their predicted paths in the p-frames. Thus, in some cases both stationary and moving objects can be omitted from the p-frame if they follow their predicted paths. If an object changes trajectory, information indicating this will be send in the p-frame.

From block 640 the process may then proceed to block 650 in which the RSU correlates incremental LDM updates received from the various vehicles or ITS stations, and updates the LCPM accordingly. These updates may also be, in some embodiments, communicated with other entities such as a centralized WACPM service, a mirrored WACPM service for business continuity, emergency services, special subscribers, centralized archives, among other options. In one embodiment, the LCPM may further be synchronized with WACPM data at this stage.

From block 650 the process may proceed back to block 610 in which the correlated data is used to construct a map (e.g. an LCPM or a WACPM) of the roadway which may then further be sent to the vehicles. In this way, the process continues to be updated for dynamic objects which may appear or be removed from the environment.

The updates to the WACPM may be in the order of multiples of seconds in some cases. For example, in one embodiment updates for the WACPM may occur every 5 or 10 seconds. The updates may be tuned to the density and speed of the traffic. For instance, on a road at a speed of 50 km/h may have an update period of 10 s, where traffic on a highway traveling at 100 km/h may have an update time of 5s. Overnight while traffic is sparse, the update period could be adjusted to 20 s for the 50 km/h roadway, while during rush-hour on a busy road, the update period could be adjusted to every 5 s.

Conversely, incremental LCPM and LDM updates from the RSU and vehicles or ITS stations would be more frequent in some embodiments than WACPM updates. For example, LCPM and LDM updates may occur between one and three seconds in some cases.

In accordance with some of the embodiments described below, network congestion may be reduced by minimizing data traffic for the embodiment of FIG. 6.

There may also be a mechanism whereby the RSU may remove old data from the LCPM and WACPM that is no longer relevant. This may include, for example, obstacles that have been removed or have left the road or area. The LCPM could signal or advise an adjacent LCPM with possible overlapping coverage area to continue tracking an object as it moves along the road.

With regard to block 650, the type of update could be based on a subscription service. Specifically, there could be a basic level of update which is free and then a vehicle owner or driver may subscribe to various levels of more refined data in some cases. The level of detail may be constrained based on regulations since a minimum set of information may be required to be received by vehicles for free in various countries. Other options are possible.

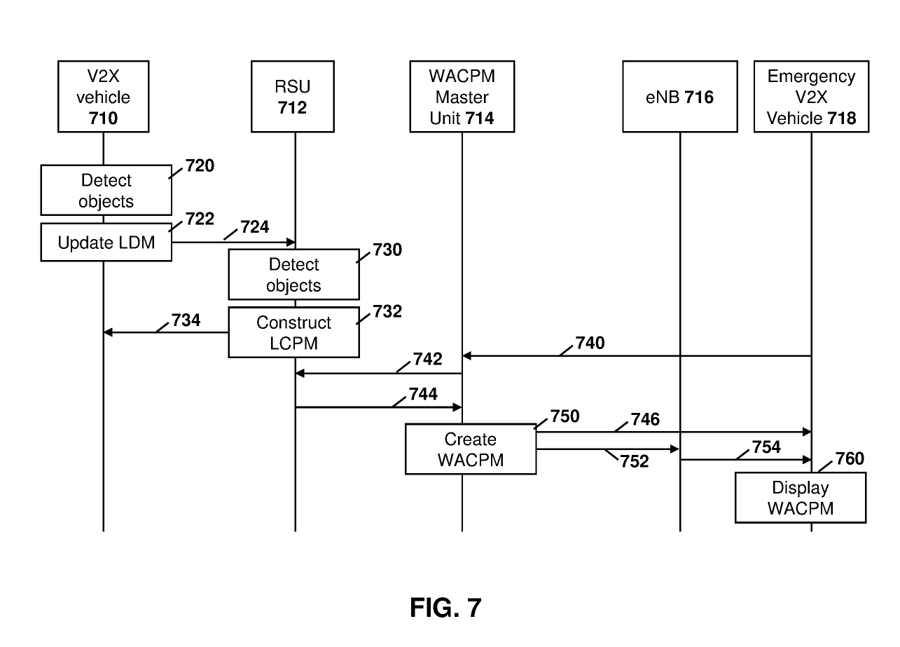

The embodiments of FIGS. 5 and 6 may be combined to allow for the distribution of the WACPM, for example to emergency vehicles. Reference is now made to FIG. 7.

In the embodiment of FIG. 7, a V2X vehicle 710 may collect information and store it in an LDM. Further, an RSU 712 may be an RSU assisting the V2X vehicle 710.

In the embodiment of FIG. 7, a WACPM master unit 714 may be any network node that is used to collect and compile a WACPM.

An emergency V2X vehicle 718 is served by an eNB 716. The eNB may contain a central or edge processing unit for the processing of the WACPM data. Other communication nodes may replace the eNB within FIG. 7.

In the embodiment of FIG. 7, V2X vehicle 710 may detect objects, as shown at block 720. The detection may be done through any number of sensors, including but not limited to LIDAR, camera, radar, among other options.

Upon detecting objects, the V2X vehicle 710 may then update its LDM, as shown by block 722. The LDM includes the objects that were detected at block 720.

As shown by message 724, the updated LDM information may then be sent to RSU 712. The RSU 712 will receive a plurality of updated LDMs from a plurality of V2X vehicles in many cases.

The RSU 712 may further include sensors that may be used to detect objects, as shown by block 730.

The RSU 712 may then take the updated LDMs and the detected objects found at block 730 and construct an LCPM at block 732.

In some cases, the LCPM may then be provided back to V2X vehicle 710, as shown by message 734.

The process may then proceed back to block 720 and which the V2X vehicle continues to detect objects and the LCPM is updated at the RSU 712.

At some point, an emergency V2X vehicle 718 may request the WACPM from the master unit 714. This request is shown as message 740. Message 740 may in some cases flow through an eNB 716. The response is shown as message 746.

The WACPM master unit 714 may then poll the RSU 712 for the LCPM data. The request for LCPM data is shown at message 742 and a response is received at message 744.

Based on the plurality of LCPMs, the master unit 714 may create a WACPM at block 750.

The WACPM may then be sent in message 752 to eNB 716. eNB 716 may then distribute the WACPM to emergency V2X vehicle 718, as shown with message 754.

Emergency vehicle may then display the WACPM as shown at block 760.

The emergency vehicle may continue to be updated by sending a request 740 and then receiving the response 746 and displaying the WACPM at block 760.

Generation of V2X Messages on Behalf of a Non-V2X Vehicle

In addition to providing information about obstacles, a V2X vehicle may also provide information with regard to non-V2X vehicles on the road. This may be done by creating an LDM and relaying such an LDM to other V2X vehicles on the road. This enables the gathering and sharing of information concerning non-V2X vehicles and perceived objects in proximity to the reporting vehicle and other V2X vehicles. Information may include awareness of the type of obstacle, including whether the object is vehicle or debris, and information such as location, direction, speed, acceleration among other such information about the detected object.

Non-V2X vehicles may, in some cases, have self-contained capabilities such as Bluetooth, LIDAR, manufacturer maintenance transmissions (cellular), among others, which may be detected by a V2X vehicle in close proximity via a proximity service (ProSe) enabled User Equipment (UE) connected to the non-V2X vehicle. The connection between the ProSe enabled UE and non-V2X vehicle may be via a wireless connection such as Bluetooth or may be via a wired connection such as a vehicle On Board Diagnostics (OBD) port. The ProSe UE onboard the Non V2X vehicle may also supply data from the ProSe UEs own sensors (GPS, accelerometers).

The data, once detected and transferred by the ProSe UE from a remote vehicle may be fused with the host V2X vehicle's own sensor data to increase the accuracy of data concerning the non-V2X vehicle perceived object.

However, in some cases the ProSe data from a remote vehicle may not be available and is an optional element.

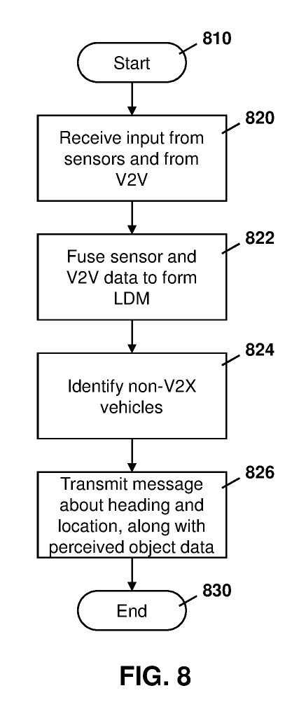

Reference is now made to FIG. 8, which shows a process for providing information with regard to non-V2X vehicles. In particular, the process starts at block 810 and proceeds to block 820 in which a computing device on a host V2X vehicle receives input from local sensors and also from received vehicle to vehicle (V2V) messages.

The process then proceeds to block 822 in which the computing device on the vehicle fuses both data sets and creates an LDM.

From block 822 the process proceeds to block 824 in which non-V2X vehicles are identified. In particular, during the fusing at block 822, sensor data (or lack of sensor data) of remote vehicles in proximity to the V2X vehicle could be compared with V2V transmissions. If a remote vehicle is not transmitting a V2V signal then this may indicate that such remote vehicle is a non-V2X enabled vehicle.

The process then proceeds from block 824 to block 826 in which the V2X vehicle may transmit messages containing its own location and heading, as well as data regarding the perceived objects. Data about perceived objects may include information that an object was detected via sensors, was detected by V2V, or was detected by both sensor and V2V information. In this case, an extra field in a message may be used to describe the source of the data in some embodiments. The message may further include information about a non-V2X enabled vehicle in some cases.

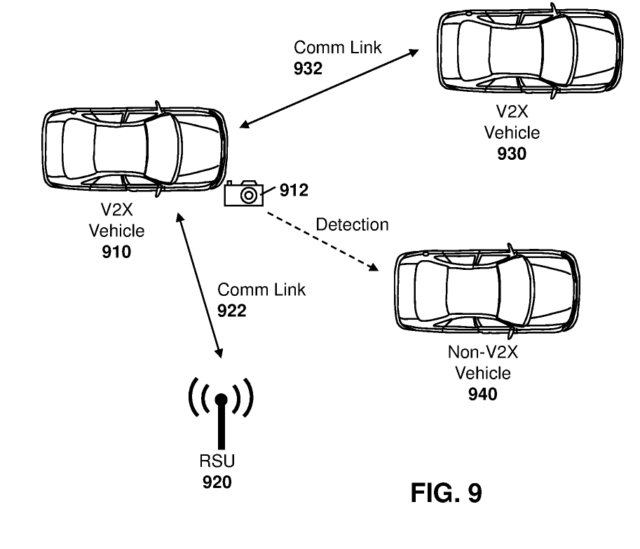

The particular, messages may include various information about the vehicles that are detected. Reference is now made to FIG. 9. In the embodiment of FIG. 9, a V2X vehicle 910 may include various sensors, including a camera sensor 912. The V2X vehicle 910 may communicate with an RSU 920 through a communication link 922.

Further, the V2X vehicle 910 may communicate with a second V2X vehicle 930 over a communication link 932.

The V2X vehicle 910 may have sensors that detect the presence of a non-V2X vehicle 940 or other objects. In particular, in the example of FIG. 9, the camera 912 may be used for non-V2X vehicle 940 detection. In this way the vehicle 910 is considered the host vehicle and it detects the presence remote vehicle 940 by way of sensors (camera) and it detects the presence of remove vehicle 930 by way of sensors (camera) plus received V2X messages directly from the vehicle 930. These are both first-hand data inputs. With perceived object messages from vehicles or infrastructure, the host vehicle 910 may also receive second-hand data about these remote vehicles as well.

Upon detecting the non-V2X vehicle 940, V2X vehicle 910 updates its LDM and constructs an ITS message such as a “Perceived Object CAM” message and event triggered “DEMN ITS” message with information about the non-V2X vehicle 940.

These ITS messages may be communicated with various entities, such as an RSU 920 if one exists in a local geographic area, with other V2X vehicles such as V2X vehicle 930, or to a node over a network such as a cellular network or other wide area network, among other options, which may support an LCPM.

The ITS messages may include various information. In one embodiment the dimensions of the non-V2X vehicle 940 may be found. For example, the dimensions may be found utilizing a camera or other sensor inputs to recognize the non-V2X vehicle and then determine the dimensions of that vehicle. Such a determination may utilize an Internet hosted database, where the vehicle dimensions may be found for a given type or model that was identified from the camera image of the vehicle. Such dimensions may then be utilized when creating a Perceived Object message.

Alternatively, limited dimensions such as height and width data may be created from camera images and LIDAR data.

In still further embodiments, license plate or facial recognition may be utilized to look up information about a particular vehicle. However, in some jurisdictions, privacy issues may prevent this.

In still further embodiments, calculated dimensions may be found for other objects besides vehicles via sensors such as camera, LIDAR or acoustic sensors. Such calculated dimensions may give approximate information such as height, length or width of the object.

In some cases, the object type may also be identified. For example, an enumerated list of object types may be defined and the object could be categorized based on this enumerated list. In other embodiments, the object type may be learned or defined from various inputs. Object types may, for example, include debris, pothole, animal, among other such categories.

Further, object recognition may be determined from sensor data and Internet hosted databases. For example, the image could be compared with other images through various processes such as artificial intelligence or machine learning to identify whether the object is a cow, tire or other such object.

In some embodiments, the ITS message may include non-V2X vehicle and object locations calculated relative to the transmitting V2X vehicle acting as a proxy. The V2X vehicle knows its own location and may work out a relative location offset of the non-V2X vehicle or object and generate a “Perceived Object” V2X message using the computed location of the non-V2X vehicle or object.

Further, if the object is moving, the V2X vehicle may find the speed and direction of the moving object. This would utilize a similar process to that described above but for speed and acceleration. A radar or laser can measure the speed of the moving object.

Entities such as an RSU or another V2X vehicle that receive a “Perceived Object CAM” may then render the detected vehicle as a non-V2X vehicle and use an algorithm to map such vehicle in a manner appropriate for a lower confidence level based on second hand data.

In particular, ETSI ITS TS 102 894-2, “Intelligent Transport Systems (ITS); Users and applications requirements; Part 2: Applications and facilities layer common data dictionary”, for example v. 1.2.1, September 2014, provides an ITS data dictionary, which is a repository that includes a list of data elements and data frames that represent data or information necessary for the realization of ITS applications and ITS facilities. Data elements and data frames may use new or modified “Perceived Object vehicle” attributes allowing for confidence, position, location, among other such attributes.

“Confidence” could take one of several defined values, which are indicative of the expected accuracy of the information provided in the proxied ITS message. Additionally, a “Perceived Object Type” could indicate the type of equipment and generating proxy. Such a type may, for example, include, but is not limited to, a smart phone, wearable or other similar electronic device on a person or vehicle such as a bicycle. Another V2X vehicle may also act as a proxy. Also, an aftermarket V2X module may be used as a proxy. For example, such an aftermarket V2X module may be used for legacy vehicles in some cases.

Other perceived object type indications or capabilities information could also be included in the ITS message. Such information may indicate, for example, whether the perceived object has cameras, radars or basic sensors. Capabilities may correspond to individual sensors or other capabilities or be grouped into capability classes.

In addition to reporting an event such as a collision avoidance maneuver, a V2X vehicle may also report the proximate cause, which may be a non-V2X vehicle maneuver adjacent to it, a vulnerable road user, or an unidentified object in the road, for example.

Avoiding Duplicated Radio Resource Reports

In a further aspect of the present disclosure, when using a wide area collective perception map the volume of data that may be provided may be significant and inefficiencies are created if multiple ITS stations are reporting the same perceived non-V2X vehicle or object. In particular, in accordance with embodiments of the present disclosure, an ITS station, whether a V2X vehicle or an RSU, can determine that a non-V2X vehicle or object exists (a perceived object), when its LDM shows the presence of the perceived object. However, this perceived object remains unreported, as no V2X messages have been received by the ITS station, corresponding to that perceived object. The ITS station may therefore only provide reports about unreported objects, which avoids multiple or duplicate reporting over the radio interface, increasing radio use efficiency and reducing network congestion.

For example, two cases are provided below. In a first case, no V2X messages may have been received for a perceived object. This may occur, for example, when a non-V2X vehicle that is being tracked by a first V2X vehicle leaves a first road and joins a second road, and where the first V2X vehicle that does not join such new road. Vehicle ITS stations on the new road will not have detected the non-V2X vehicle before.

In a second case, information regarding an object or non-V2X vehicle may not have been received during a threshold time period, x*T_{CAM}, where T_{CAM} is the expected period of a CAM message. For example, the CAM reporting may be expected every 100 ms.

In the above, x may be defined to be greater than one to allow for the fact that radio transmission and reception is not completely reliable, and to avoid V2X vehicles producing “perceived object” messages prematurely.

The second case may occur, for example, if a non-V2X vehicle was being tracked by a first proxy V2X vehicle but the first V2X vehicle then overtakes the non-V2X vehicle, falls behind the non-V2X vehicle, or has pulled off the roadway, among other options.

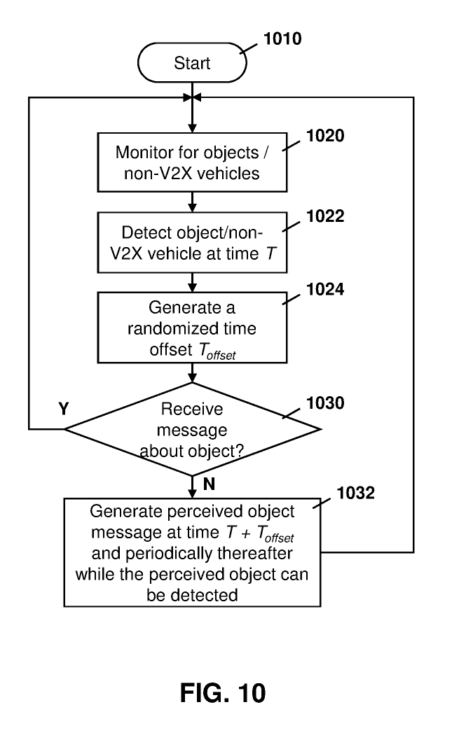

In both of the above cases, multiple V2X vehicles may detect the absence of reporting of perceived objects or non-V2X vehicles at the same time. Therefore, in accordance with a further embodiment of the present disclosure, it may be possible to avoid multiple V2X vehicles generating messages indicating perception of the same object or non-V2X vehicle by utilizing a time offset. Reference is now made to FIG. 10.

The process of FIG. 10 starts a block 1010 and proceeds to block 1020 in which a computing device on a V2X vehicle monitors for objects or non-V2X vehicles. This may be done, for example, utilizing sensors such as radar, LIDAR, cameras, among other options.

From block 1020 the process proceeds to block 1022 in which the computing device on the V2X vehicle detects at time T that V2X messages indicating perception of a detected object or non-V2X vehicle has not been received over the preceding period x*T_{CAM}.

From block 1022 the process proceeds to block 1024 in which the computing device at the V2X vehicle generates a randomized time offset T_{offset}. The T_{offset} might typically be measured in milli-secs and could be calculated in a number of ways. For example, in a first embodiment the T_{offset} could be identified as an Identity modulo T_{CAM}. The Identity could for example be an IMSI or IEEE 802.11p MAC address in some cases. In other cases, the Identity could be any identity which could be converted into an integer providing it is sufficiently large e.g. greater than 2 times T_{CAM} in this example.

To illustrate this method further, by way of example the T_{CAM} could be set to 100 when the CAM messages are sent out at a 100 ms period. The effect of performing the modulo operation is to produce a value that is between 0 and 99, giving a T_{offset} value between 0 and 99 ms. Because the Identity that is used by different ITS stations are assumed to be uncorrelated, the probability of vehicles generating any of the T_{offset} periods between 0 and 99 ms is evenly distributed, and in this way the computation of T_{offset} by a vehicle is similar to performing a single random number draw. Because the range of values is quite large, i.e. 100 then the chances of any two vehicles computing the same number are relatively low. If desired this probability of collision can easily be reduced further by providing more granularity in the possible T_{offset} values.

Other ways to generate the randomized time offset T_{offset} could also be used.

From block 1024, once the T_{offset} has been generated, the process proceeds to block 1030 at time T+T_{offset}. At block 1030 a check is made to determine whether a message has been received about the detected object or non-V2X vehicle from any other ITS station. In other words, the computing device at the V2X enabled vehicle will wait for the offset time prior to making a determination of whether it should itself generate messages about the detected object or non-V2X vehicle.

If no message about the perceived object has been detected during the offset time period, the process proceeds from block 1030 to block 1032 in which the computing device on the V2X vehicle generates a perceived object message at time T+T_{offset}. At this point, the V2X vehicle has become the proxy for the object or the non-V2X vehicle and may continue to report about that object or non-V2X vehicle as long as such object or non-V2X vehicle is within the detection distance of the proxy V2X vehicle.

From block 1032 the process proceeds to back to block 1020 to further monitor for objects or non-V2X vehicles.

Conversely, if a message is received about the perceived object during the offset time period, then the process proceeds from block 1030 back to block 1020 to further monitor for other objects or non-V2X vehicles. In this case, another vehicle has become the proxy for the object or non-V2X vehicle and the current V2X vehicle does not need to provide any reports to avoid duplication.

Variants of this algorithm are also envisaged to support the possibility that it may be desirable to have more than one vehicle (e.g. at least n vehicles) reporting on a particular object or non-V2X equipped vehicle. This might be desirable for example to make it harder for a single potentially malicious V2X entity from generating all the perceived object indications. The algorithm would work in broadly the same way with the difference that a V2X equipped vehicle would only make the determination as to whether it should transmit an indication of the perceived object or non-V2X vehicle if that perceived object or non-V2X vehicle is being indicated by <n other vehicles.

Once a V2X vehicle has started producing messages on behalf of an object or non-V2X vehicle, other V2X vehicles may go back to block 1020 to continue to monitor for objects or non-V2X vehicles. Such other V2X vehicles will then see if the proxy ITS station stops transmitting about the perceived objects and therefore may assume the role of the proxy V2X vehicle at that point.

The above therefore provides a method and system to allow V2X vehicle and RSU to provide and receive wide area information on perceived objects detected by other V2X vehicles and remote infrastructure using local sensors and collective map fusion establishing a network wide collective perception map.

The above embodiments also provide a solution to allow a V2X vehicle to act as a proxy to a non-V2X vehicle in order to send and receive collective perception information on behalf of such non-V2X vehicle to other vehicles in the vicinity. This provides warnings and guidance information for all vehicles that are part of the intelligent transportation system.

The above embodiments may be performed at a computing device at an ITS station such as a vehicle or an RSU, or at a network element.

The servers, nodes, ITS stations and network elements described above may be any computing device or network node. Such computing device or network node may include any type of electronic device, including but not limited to, mobile devices such as smartphones or cellular telephones. Examples can further include fixed or mobile user equipment, such as internet of things (IoT) devices, endpoints, home automation devices, medical equipment in hospital or home environments, inventory tracking devices, environmental monitoring devices, energy management devices, infrastructure management devices, vehicles or devices for vehicles, fixed electronic devices, among others. Vehicles includes motor vehicles (e.g., automobiles, cars, trucks, buses, motorcycles, etc.), aircraft (e.g., airplanes, unmanned aerial vehicles, unmanned aircraft systems, drones, helicopters, etc.), spacecraft (e.g., spaceplanes, space shuttles, space capsules, space stations, satellites, etc.), watercraft (e.g., ships, boats, hovercraft, submarines, etc.), railed vehicles (e.g., trains and trams, etc.), and other types of vehicles including any combinations of any of the foregoing, whether currently existing or after arising.

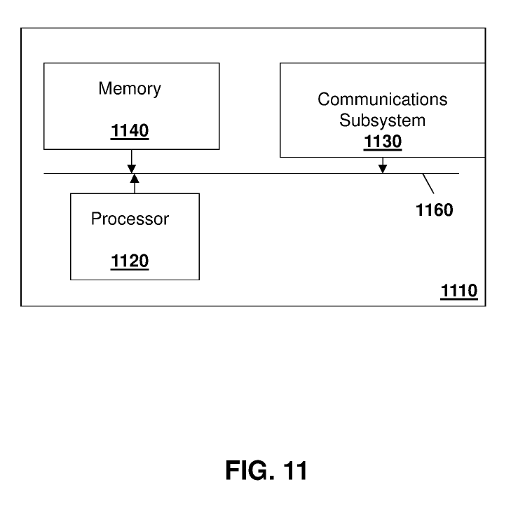

One simplified diagram of a computing device is shown with regard to FIG. 11. The computing device of FIG. 11 could be any mobile device, portable device, ITS station, server, or other node as described above.

In FIG. 11, device 1110 includes a processor 1120 and a communications subsystem 1130, where the processor 1120 and communications subsystem 1130 cooperate to perform the methods of the embodiments described above. Communications subsystem 1120 may, in some embodiments, comprise multiple subsystems, for example for different radio technologies.

Processor 1120 is configured to execute programmable logic, which may be stored, along with data, on device 1110, and shown in the example of FIG. 11 as memory 1140. Memory 1140 can be any tangible, non-transitory computer readable storage medium. The computer readable storage medium may be a tangible or in transitory/non-transitory medium such as optical (e.g., CD, DVD, etc.), magnetic (e.g., tape), flash drive, hard drive, or other memory known in the art.

Alternatively, or in addition to memory 1140, device 1110 may access data or programmable logic from an external storage medium, for example through communications subsystem 1130.

Communications subsystem 1130 allows device 1110 to communicate with other devices or network elements and may vary based on the type of communication being performed. Further, communications subsystem 1130 may comprise a plurality of communications technologies, including any wired or wireless communications technology.

Communications between the various elements of device 1110 may be through an internal bus 1160 in one embodiment. However, other forms of communication are possible.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be employed. Moreover, the separation of various system components in the implementation described above should not be understood as requiring such separation in all implementations, and it should be understood that the described program components and systems can generally be integrated together in a single software product or packaged into multiple software products.

Also, techniques, systems, subsystems, and methods described and illustrated in the various implementations as discrete or separate may be combined or integrated with other systems, modules, techniques, or methods. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and may be made.

While the above detailed description has shown, described, and pointed out the fundamental novel features of the disclosure as applied to various implementations, it will be understood that various omissions, substitutions, and changes in the form and details of the system illustrated may be made by those skilled in the art. In addition, the order of method steps are not implied by the order they appear in the claims.

When messages are sent to/from an electronic device, such operations may not be immediate or from the server directly. They may be synchronously or asynchronously delivered, from a server or other computing system infrastructure supporting the devices/methods/systems described herein. The foregoing steps may include, in whole or in part, synchronous/asynchronous communications to/from the device/infrastructure. Moreover, communication from the electronic device may be to one or more endpoints on a network. These endpoints may be serviced by a server, a distributed computing system, a stream processor, etc. Content Delivery Networks (CDNs) may also provide may provide communication to an electronic device. For example, rather than a typical server response, the server may also provision or indicate a data for content delivery network (CDN) to await download by the electronic device at a later time, such as a subsequent activity of electronic device. Thus, data may be sent directly from the server, or other infrastructure, such as a distributed infrastructure, or a CDN, as part of or separate from the system.

Typically, storage mediums can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly a plurality of nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

Further, the following clauses also provide for aspects and implementations of the embodiments herein.

AA. A method at a computing device, the method comprising: monitoring for objects using at least one sensor at the computing device; detecting an object; generating a randomized time offset; monitoring a communications channel for reports about the detected object for a time period equal to the randomized time offset; and generating a perceived object message if no report about the detected object is received during the time period.

BB. The method of clause AA., wherein the computing device is associated with an intelligent transportation system station.

CC. The method of clause AA, further comprising, after the generating, monitoring the object while at least one sensor still detects the object.

DD. The method of clause AA, wherein the object is a vehicle.

EE. The method of clause AA, wherein the randomized time offset is generated based on an identity, modulo a standard reporting period.

FF. The method of clause EE, wherein the identity is an international mobile subscriber identity or an 802.11 Medium Access Control address.

GG. The method of clause EE, wherein the standard reporting period is a reporting period for a cooperative awareness message or a basic safety message.

HH. A computing device, comprising a processor; and a communications subsystem, wherein the computing device is configured to: monitor for objects using at least one sensor at the computing device; detect an object; generate a randomized time offset; monitor a communications channel for reports about the detected object for a time period equal to the randomized time offset; and generate a perceived object message if no report about the detected object is received during the time period.

II. The computing device of clause HH., wherein the computing device is associated with an intelligent transportation system station.

JJ. The computing device of clause HH, wherein the computing device is further configured to, after generating the perceived object report, monitor the object while at least one sensor still detects the object.

KK. The computing device of clause HH, wherein the object is a vehicle.

LL. The computing device of clause HH, wherein the randomized time offset is generated based on an identity, modulo a standard reporting period.

MM. The computing device of clause LL, wherein the identity is an international mobile subscriber identity or an 802.11 Medium Access Control address.

NN. The computing device of clause LL, wherein the standard reporting period is a reporting period for a cooperative awareness message or a basic safety message.

OO. A computer readable medium for storing instruction code, which, when executed by a processor of a computing device, cause the computing device to: monitor for objects using at least one sensor at the computing device; detect an object; generate a randomized time offset; monitor a communications channel for reports about the detected object for a time period equal to the randomized time offset; and generate a perceived object message if no report about the detected object is received during the time period.

1. A method at a network element for collective perception in an intelligent transportation system, the method comprising:
receiving, from each of a plurality of intelligent transportation system stations, a local dynamic map;
creating, based on the local dynamic map from each of the plurality of intelligent transportation system stations, a local collective perception map; and
distributing the local collective perception map to at least one of the plurality of intelligent transportation system stations.

2. The method of claim 1, further comprising synchronizing the local collective perception map with a wide area collective perception map at a wide area collective perception map master unit.

3. The method of claim 1, wherein the distributing utilizes an Intra-coded picture frame.

4. The method of claim 1, wherein the receiving uses a predicted picture frame having only incremental changes from a previously received local dynamic map.

5. The method of claim 1, wherein the creating removes objects from the local collective perception map that are no longer within received local dynamic maps.

6. The method of claim 1, wherein the local dynamic map received from at least one of the plurality of intelligent transportation system stations includes information about non-intelligent transportation system vehicles.

7. The method of claim 6, wherein the information includes at least a speed and direction of movement of the non-intelligent transportation system vehicles.

8. The method of claim 1, wherein only one local dynamic map from the plurality of received local dynamic maps includes information about a previously unreported object for the local collective perception map.

9. The method of claim 1, wherein the network element is a road side intelligent transportation system station.

10. A network element for collective perception in an intelligent transportation system, the network element comprising:
a processor; and
a communications subsystem,
wherein the network element is configured to:
receive, from each of a plurality of intelligent transportation system stations, a local dynamic map;
create, based on the local dynamic map from each of the plurality of intelligent transportation system stations, a local collective perception map; and
distribute the local collective perception map to at least one of the plurality of intelligent transportation system stations.

11. The network element of claim 10, wherein the network element is further configured to synchronize the local collective perception map with a wide area collective perception map at a wide area collective perception map master unit.

12. The network element of claim 10, wherein the network element is configured to distribute using an Intra-coded picture frame.

13. The network element of claim 10, wherein the network element is configured to receive using a predicted picture frame having only incremental changes from a previously received local dynamic map.

14. The network element of claim 10, wherein the network element is configured to create by removing objects from the local collective perception map that are no longer within received local dynamic maps.

15. The network element of claim 10, wherein the local dynamic map received from at least one of the plurality of intelligent transportation system stations includes information about non-intelligent transportation system vehicles.

16. The network element of claim 15, wherein the information includes at least a speed and direction of movement of the non-intelligent transportation system vehicles.

17. The network element of claim 10, wherein only one local dynamic map from the plurality of received local dynamic maps includes information about a previously unreported object for the local collective perception map.

18. The network element of claim 10, wherein the network element is a road side intelligent transportation system station.

19. A computer readable medium for storing instruction code, which, when executed by a processor of a network element configured for collective perception in an intelligent transportation system cause the network element to:
receive, from each of a plurality of intelligent transportation system stations, a local dynamic map;
create, based on the local dynamic map from each of the plurality of intelligent transportation system stations, a local collective perception map; and
distribute the local collective perception map to at least one of the plurality of intelligent transportation system stations.
